(19) United States
(12) Patent Application Publication
(10) Pub. No.: US 2011/0151349 A1
(43) Pub. Date: Jun. 23, 2011

(54) DOUBLE-ELECTROLYTE FUEL-CELL

(75) Inventor: Yoed Tsur, Mishmar Ha'Emeq (IL)

(73) Assignee: TECHNION RESEARCH & DEVELOPMENT FOUNDATION LTD., Haifa (IL)

(21) Appl. No.: 12/997,327

(22) PCT Filed: Jun. 10, 2009
(86) PCT No.: PCT/IL2009/000578

§ 371 Date: Mar. 3, 2011

Related U.S. Application Data
(60) Provisional application No. 61/060,308, filed on Jun. 10, 2008.

(51) Int. Cl. H01M 8/24; H01M 8/14; H01M 8/10; H01M 8/08

(52) U.S. Cl. 429/464; 429/472; 429/488; 429/492; 429/498; 429/478; 429/465

(57) ABSTRACT

A double-electrolyte fuel-cell is presented for generating electrical energy from chemical fuel. The fuel-cell includes an anode, a cathode as well as both an anion-conducting electrolyte and a cation-conducting electrolyte. A fuel-cell stack is also presented consisting of a plurality of double-electrolyte fuel-cells.

### FIELD OF THE INVENTION

The present invention relates to fuel-cells. More specifically, the invention relates to fuel-cells incorporating both anion-conducting and cation-conducting electrolytes.

### BACKGROUND

A fuel-cell is an electrochemical energy converter in which electricity is produced directly from a fuel. The fuel is separated from an oxidant by an electrolyte. The electrolyte has low electronic conductivity, but high ionic conductivity. Depending upon the type of fuel-cell, the electrolyte conducts either cations (such as hydrogen ions) or anions (such as oxygen ions). The flow of ions across the electrolyte drives electronic flow from an anode in contact with the fuel to a cathode in contact with the oxidant. As long as fuel and oxidant continue to flow into the fuel-cell, a potential difference is maintained between the anode and cathode of the cell.

Two typical fuel-cells of the prior art are shown in FIGS. 1a and 1b. Referring particularly to FIG. 1a, a schematic representation shows a typical hydrogen-oxygen proton exchange fuel-cell 10 of the prior art, which uses a cation-conducting electrolyte. The electrolyte is a proton exchange membrane 12 which divides a hydrogen fuel 11 from an oxygen oxidant 13. The hydrogen fuel 11 is in contact with an anode 14 and the oxidant 13 is in contact with a cathode 16. The anode 14 is coated in a catalyst 17 such as platinum which calatytically separates electrons from the hydrogen, the electrons 18 flow from the anode 14 to the cathode 16 via a load 20. The hydrogen ions 15 are free to flow through the cation-conducting proton exchange membrane 12 to the cathode side where, in the presence of a second catalyst 19, coating the cathode 16, they react with the oxygen 13, producing water molecules 22. The water 22 waste product may be drained from the cathode side of the fuel-cell 10.

FIG. 1b shows a schematic representation of a typical solid oxide fuel-cell 30 of the prior art. Unlike the proton exchange fuel-cell 10 shown in FIG. 1a, the electrolyte used by the solid oxide fuel-cell 30 is conductive to anions. The electrolyte is typically a solid oxide ceramic 32, such as zirconia doped with yttria. The anion-conducting electrolyte 32 divides the fuel 31, for example hydrogen, which is in contact with the anode 34, from the oxygen oxidant 33, which is in contact with the cathode 36. At the cathode 36, oxygen catalytically reacts with a supply of electrons to four oxygen ions 35. The oxygen ions 35 flow through the anion-conducting electrolyte membrane 32. At the anode 34, the oxygen ions 35 catalytically react with the hydrogen 31 producing water molecules 42 and electrons 38 to flow from the anode 34 to the cathode 36 via a load 40. The waste water 42 is drained from the anode 34 together with the residual fuel.

Other fuel-cells use either cation-conducting electrolytes like the proton exchange fuel-cell 10 or anion-conducting electrolytes like the solid oxide fuel-cell 30. Generally, solid oxide type fuel-cells are considered more fuel flexible because they may use anion-conducting electrolytes with the fuel remaining at the anode side. Therefore, solid oxide fuel cells are operable with a wide variety of fuels as well as hydrogen such as natural gas, biogas, ethanol, methanol, carbon monoxide and the like. Moreover, solid oxide type fuel-cells are usually considered the most efficient type of fuel cells.

Solid-oxide fuel cells suffer from a major drawback, however, as the solid oxide electrolytes become significantly less conductive to anions at temperatures below about 600 degrees Celsius or so. Consequently, solid oxide fuel-cells need to be heated to an operating temperature of around 1000 degrees Celsius. As a result of their high operating temperatures, solid oxide fuel-cells have a relatively slow start-up time.

The voltage generated by a fuel-cell is relatively low, typically around 0.6 volts and rarely higher than 0.7 volts. In order to generate higher voltages, fuel-cell stacks are constructed in which many fuel-cells are combined in series. A section of a typical solid oxide fuel-cell stack 50 of the PRIOR ART is represented in FIG. 1c. Each solid oxide fuel-cell 60 includes an anode layer 62, an electrolyte layer 64, a cathode layer 66 and an interconnect layer 68. The anode layer 62, electrolyte layer 64 and cathode layer 66 are the functional layers of each fuel-cell 60, while the interconnect layer 68 serves to connect adjacent fuel-cells 60 in series.

The interconnect layer 68 is typically configured to have an oxidant-channel 67 and a fuel-channel 69. The oxidant-channel 67 provides access to the cathode layer 66 for an oxidant, typically air. The fuel-channel 69 allows the flow of fuel to the anode layer 62 as well as the drainage of waste products such as water and carbon dioxide.

Hydrogen fuel-cells are considered a particularly clean source of electricity, nevertheless hydrogen serves as an energy carrier rather than a true fuel and the production of hydrogen is itself highly energetic and very expensive. Moreover, the infrastructure and safety measures required for making hydrogen fuel cells practical in widely used applications such as transportation hinders the penetration of this technology.

There need remains therefore for fuel-cells with reduced cost per power unit. Such fuel-cells may provide more practical solutions for common applications, with significant environmental advantages. Moreover, there is a further need for fuel cells able to use commonly available fuels such as methane, which have existing supply infrastructure. Embodiments of the present invention address this need.

### SUMMARY OF THE INVENTION

Embodiments of the present invention are directed towards providing a double-electrolyte fuel-cell comprising: at least one anode; at least one cathode; at least one anion-conducting electrolyte, and at least one cation-conducting electrolyte.

Variously, the cation-conducting electrolyte may be selected from the group consisting of: proton exchange membranes, alkaline solution, polymer membranes, nafion, polybenzimidazole fiber, molten phosphoric acid, and proton conducting ceramic oxides. The anion-conducting electrolyte may be selected from the group consisting of: ceramic oxides, doped zirconium dioxide, doped cerium oxide, and molten alkaline carbonates.

Typically, the fuel-cell comprises a fuel channel for delivering fuel to the anode and an oxidant channel for delivering oxidant to the cathode. Optionally, the fuel-cell further comprises a porous water collection layer sandwiched between a proton conductor and an oxygen ion conductor.

According to various embodiments the fuel-cell may comprise: an anode layer sandwiched between one anion-conducting electrolyte and one cation-conducting electrolyte; a first cathode layer in contact with the anion conducting electrolyte, and a second cathode layer in contact with the cation conducting electrolyte.

Other embodiments of the invention are directed towards providing a fuel-cell stack comprising a plurality of double-electrolyte fuel-cells.

Typically, the fuel-cell stack comprises a plurality of double-electrolyte fuel-cells conductively connected in series via electrically conductive interconnect layers. Optionally, wherein the anode layer of at least one the fuel-cell is conductively connected to the first cathode layer and the second cathode layer of an adjacent fuel-cell via an interconnect layer.

Alternatively, the fuel-cell stack comprises a plurality of double-electrolyte fuel-cells conductively connected in parallel via electrical conductors connecting cathode layers to one another and anode layers to one another.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1a is a schematic representation of a proton exchange membrane fuel-cell of the PRIOR ART;

FIG. 1b is a schematic representation of a fuel-cell based on an oxygen ion conducting electrolyte of the PRIOR ART;

FIG. 1c is a schematic representation of a solid oxide fuel-cell stack of the PRIOR ART;

FIG. 2a is a schematic representation showing a section through of a double-electrolyte fuel-cell according to a first embodiment of the invention;

FIG. 2b is an oblique view showing an oblique view of a hexagonal double-electrolyte fuel-cell according to the first embodiment of the invention;

FIG. 3a is a schematic representation showing a double-electrolyte fuel-cell according to a second embodiment of the invention;

FIG. 3b is a schematic representation showing a pair of double-electrolyte fuel-cell according to a second embodiment of the invention, and

FIG. 4 is a schematic representation of a fuel-cell stack according to a third embodiment of the invention.

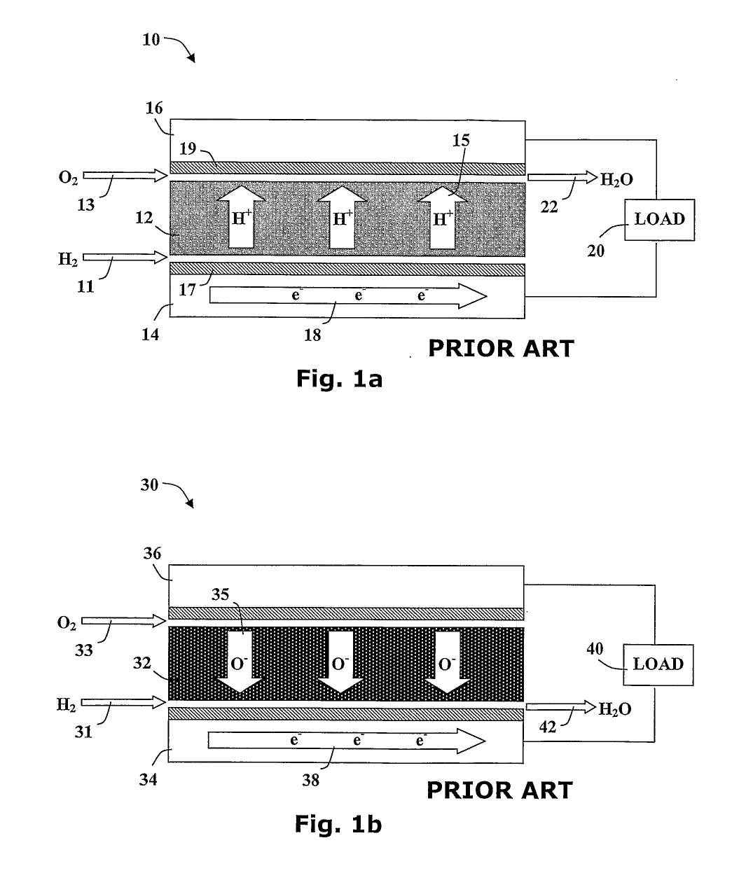

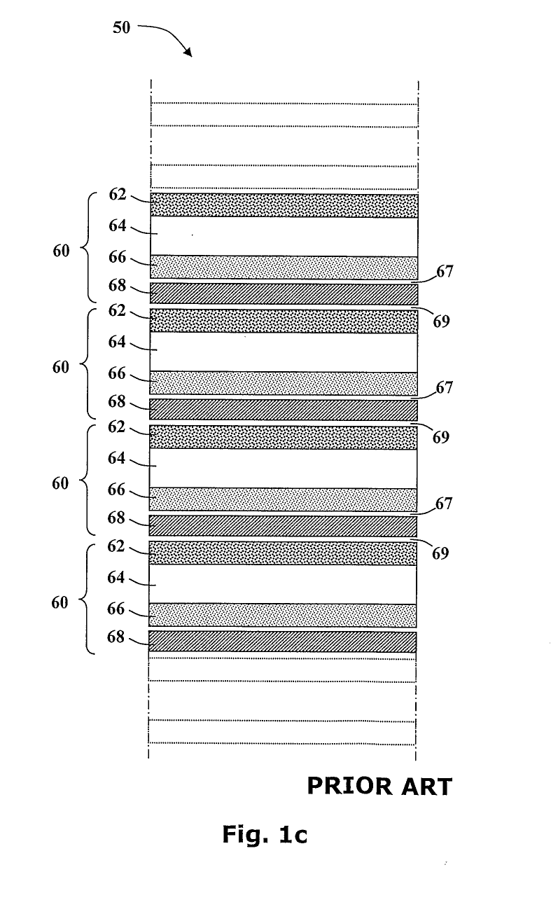

### DESCRIPTION OF THE PREFERRED EMBODIMENTS

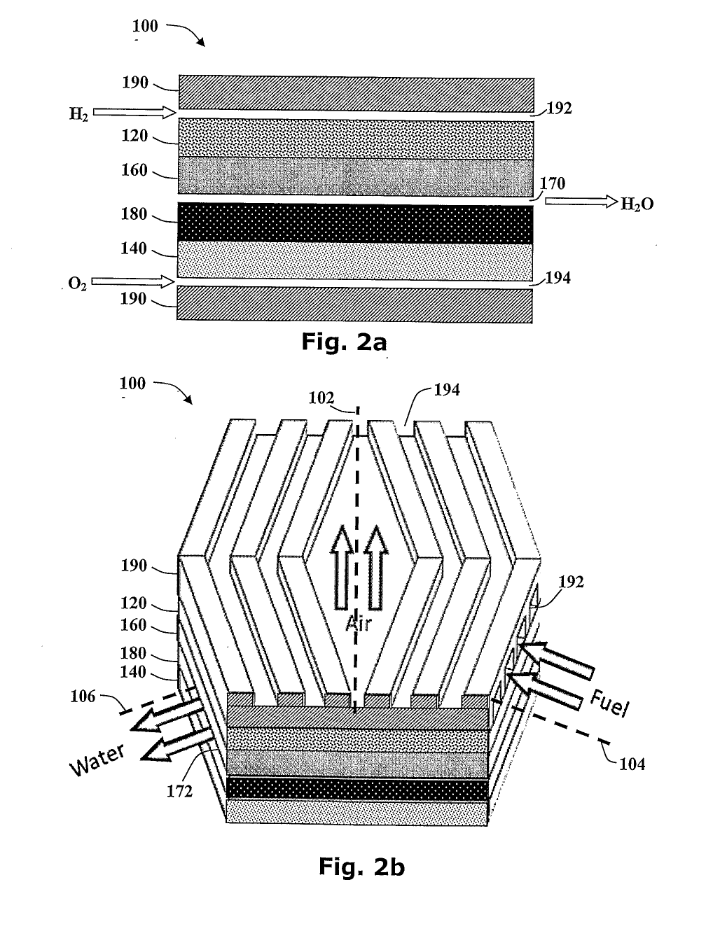

Reference is now made to FIG. 2a which is a schematic representation showing a section through of a double-electrolyte fuel-cell according to a first embodiment of the invention. The double-electrolyte fuel-cell 100 includes an anode 120, a cathode 140, a cation-conducting electrolyte 160 and an anion-conducting electrolyte 180.

Fuel-cells of the prior art use either cation-conducting electrolytes, such as the proton exchange membrane, or anion-conducting electrolytes, such as stabilized zirconia or ceria. In contradistinction to the prior art, it is a particular feature of embodiments of the current invention that the double-electrolyte fuel-cell 100 includes both a cation-conducting electrolyte 160 and an anion-conducting electrolyte 180. The specific electrolytes selected for use with the fuel-cell will vary according to requirements.

Examples of cation-conducting electrolytes 160 include proton exchange membranes such as polymer membranes, nafion, alkaline solution, molten phosphoric acid, polybenzimidazole fiber, proton conducting ceramic oxides for example yttria-doped barium cerate and the like. Examples of anion-conducting electrolytes 180 include ceramic oxides such as doped zirconium dioxide, yttria stabilized zirconia, doped cerium oxide or gadolinia doped ceria, and molten alkaline carbonates and the like.

Typically, an electron-conducting interconnect layer 190 is provided for connecting multiple double-electrolyte fuel-cells 100 into a fuel-cell stack. A fuel-channel 192 on the anode side of the interconnect layer 190 allows fuel, such as hydrogen, methane, methanol or the like, to enter the fuel-cell 100 coming into contact with the anode 120. An oxidant-channel 194 on the cathode side of the interconnect layer 190 allows oxidant, such as oxygen, air and the like, to enter the fuel-cell 100, coming into contact with the cathode 140. The channels may be constructed by an intentional geometrical structure or by directed porosity for example.

It is noted that double-electrolyte fuel-cells 100 according to a first embodiment of the invention typically include a porous layer 170 sandwiched between the anion-conducting electrolyte 120 and the cation-conducting electrolyte 140. In operation of double-electrolyte fuel-cells of the first embodiment, cations, such as protons are catalytically separated from the fuel at the anode and flow through the cation-conducting electrolyte 120 to the porous layer 170. Anions, such as oxide ions, are catalytically produced at the cathode and flow through the anion-conducting electrolyte 140 to the porous layer 170. In the porous layer, anions and cations may react, producing waste products, typically water.

It is therefore a feature of the double-electrolyte fuel-cell 100 of the first embodiment, that the waste products, such as water, are produced in the porous layer 170. In prior art fuel-cells either the fuel or oxidant is contaminated by waste products and the efficiency of the fuel cell may be compromised as a result. In contradistinction to the prior art, waste may be drained from the double-electrolyte fuel-cell 100 of the first embodiment via the separate porous layer 170 without coming into contact with the fuel or the oxidant.

It is further noted that because uncontaminated residual fuel and oxidant may be recycled without further processing, embodiments of the invention may minimize fuel wastage consequently reducing running costs of the fuel-cell as well as its environmental footprint.

Referring now to FIG. 2b, an oblique view is shown of a hexagonal double-electrolyte fuel-cell 100 according to the first embodiment of the invention. The hexagonal configuration allows individual axes for a fuel-channel 192, an oxidant-channel 194 and a waste-channel 172 each angularly separated from the others.

The double-electrolyte fuel-cell 100 has a hexagonal interconnect layer 190, a hexagonal anode 120 layer, a hexagonal cathode 140 layer, a hexagonal cation-conducting electrolyte 160 layer and a hexagonal anion-conducting electrolyte 180 layer.

The interconnect layer 190 has a grooved upper surface providing an oxidant-channel 194 along a first axis 102. When multiple double-electrolyte fuel-cells of the first embodiment are stacked into a fuel-cell stack oxidant-channel 194 allows air or other oxidants to access the cathode layer 140 of an adjacent fuel-cell (not shown). The lower surface of the interconnect layer 190 is grooved along a second axis 104 sixty degrees removed from the first axis 102.

Anions and cations flow through the electrolytes 160, 180 and react in a porous layer 170 sandwiched between them. Waste may be drained along a third axis 106 sixty degrees removed from both the first axis 102 and the second axis 104.

The hexagonal configuration of the first embodiment allows fuel to be provided along the second axis 104 and waste products to be drained along the third axis 106 without coming into contact and without interfering with one other. It is noted, however, that other configurations may be preferred as suit requirements.

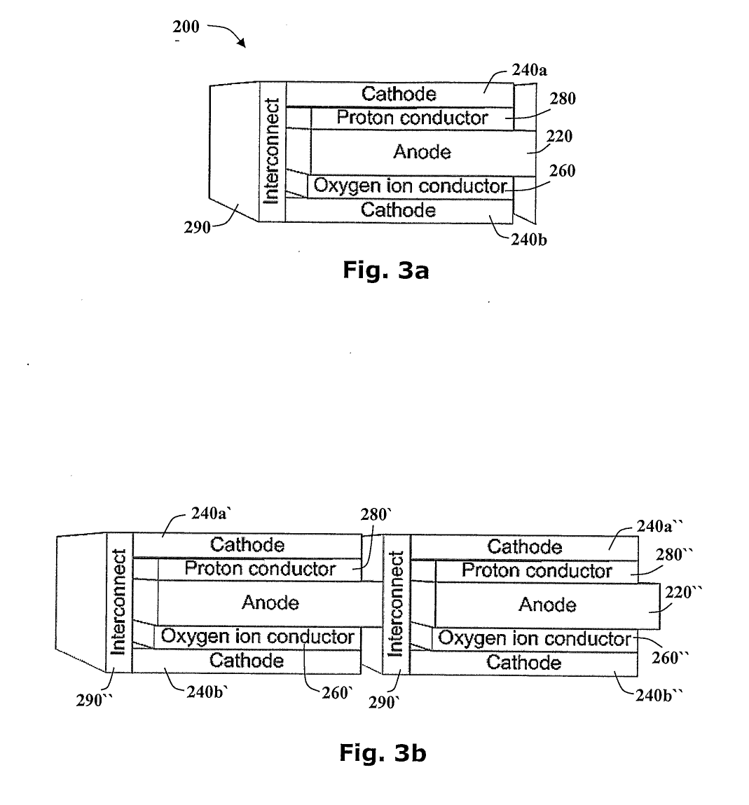

With reference now to FIG. 3a, a schematic representation shows a section through a double-electrolyte fuel-cell 200 according to a second embodiment of the invention. The double-electrolyte fuel-cell 200 of the second embodiment includes an anode layer 220 sandwiched between an anion-conducting electrolyte 260 and a cation-conducting electrolyte 280. The fuel-cell 200 is edged by two cathode layers 240a, 240b. The first cathode layer 240a is in contact with the cation conducting electrolyte, and the second cathode layer 240b is in contact with said anion conducting electrolyte.

The cathode layers 240a, 240b are in contact with oxidant. Typically, the cathode layers 240a, 240b are porous and the surrounding air serves as the oxidant. Anions, such as oxygen ions, produced at the boundary between the second cathode layer 240b and the anion-conducting electrolyte 260, may flow through the anion-conducting electrolyte 260 towards the anode layer 220. Preferably, the anode layer 220 is constructed from a porous material such as a ceria-nickel ceramic-metal composite or the like.

It is a particular feature of the second embodiment of the invention that two possibilities are available for cations produced at the anode 220. According to a first possibility, cations may react with anions traveling through the anion-conducting electrolyte layer 260 from the second cathode layer 240b. Alternatively cations may flow across the cation-conducting electrolyte 280 towards the first cathode layer 240a, where they may react with anions produced at the boundary between the first cathode layer 240a and the cation-conducting electrolyte 280.

As noted above, prior art solid-oxide fuel-cells are generally more efficient than fuel-cells having only cation-conducting electrolytes, however, solid-oxide electrolytes are significantly less conductive to ions at low temperatures. Therefore, due to their high operating temperatures, solid-oxide fuel-cells suffer from slow start-up rates. It is noted, however, that the double-electrolyte fuel-cell 200 of the second embodiment may reduce the start-up time considerably.

It is further noted that the potential difference generated between the anode 220 and cathodes 240a, 240b of the fuel cell 200 is electrolyte independent and depends only upon the fuel and oxidant. Using the double-electrolyte fuel cell, energy may be converted within a larger temperature range than prior art solid oxide fuel-cells.

Because the voltage generated by fuel-cells is relatively low, double-electrolyte fuel-cells 200 of the second embodiment are typically connected in series to produce fuel-cell stacks. Referring now to FIG. 3b, a schematic representation is shown of two double-electrolyte fuel-cells 200′, 200″ of the second embodiment of the invention connected by an interconnect layer 290′. Note that the interconnect 290′ layer is perpendicular to the anode layers 220′, 220″, electrolyte layers 260′, 260″, 280′, 280″ and cathode layers 240a′, 240a″ 240b′, 240b″ of the adjacent fuel-cells 200′, 200″. The perpendicular configuration allows the interconnect layer 290 to be connected to the anode 220′ of the first fuel-cell 200′ and both the cathodes 240a″, 240b″ of the adjacent fuel-cell 200″. Note that the electrolyte layers and second anode layer 220″ are preferably insulated from the interconnect layer 290′.

A further advantage of the double-electrolyte fuel-cell 200 of the second embodiment is that the double-electrolyte fuel-cell 200 is more flexible than single-electrolyte fuel-cells with regards to the fuel which it may use. In contradistinction to single-electrolyte fuel-cells of the prior art, double-electrode fuel-cells 200 of the second embodiment have two energy conversion mechanisms, one associated with the anion-conducting electrolyte and the other with the cation-conducting electrolyte.

Consequently, mixed fuels may therefore be used which contain a plurality of reactants, such as mixtures of hydrogen, methane and carbon monoxide for example in synthetic gas. The various reactants of mixed fuels produce a variety of cations which either flow through the cation-conducting electrolyte 240 or react with anions coming through the anion-conducting electrolyte 240 depending upon conditions. It is noted, however, that the various embodiments of the double-electrolyte fuel-cell 200 may be optimized for specific fuel types as required.

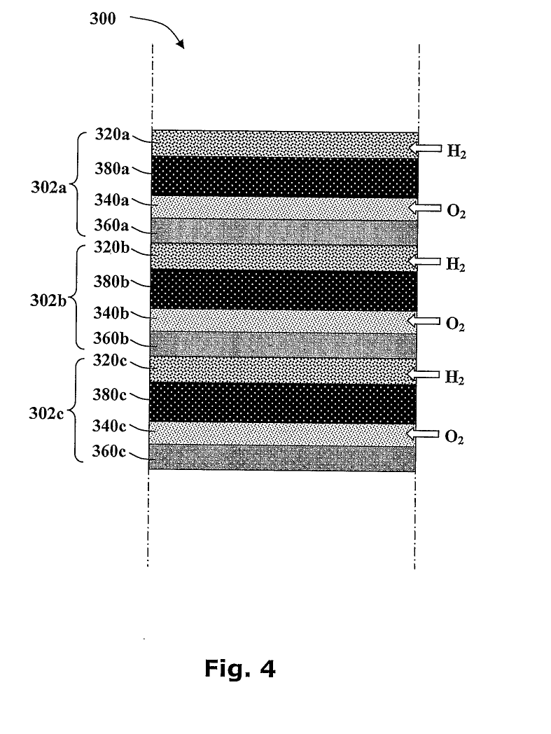

A third embodiment of the invention is represented in FIG. 4 showing a schematic representation of a section of a double-electrolyte fuel-cell stack 300. The double-electrolyte fuel-cell stack 300 includes a plurality of double-electrolyte fuel-cells 302a-c connected via their electrolyte layers 320a-c, 340a-c. It is noted that in contradistinction to prior art fuel-cell stacks, the fuel-cell stack 300 according to the third embodiment of the invention, does not include any interconnect layers.

Each double-electrolyte fuel-cell 302, making up the double-electrolyte fuel-cell stack 300, includes an anode layer 320, a cathode layer 340, a cation-conducting electrolyte 360 and an anion-conducting electrolyte 380.

The anode layers 320 are preferably constructed from a porous material into which fuel may be introduced. Fuel is catalytically separated at the anode 320 into electrons and cations which may flow through the cation-conducting electrolyte towards a cathode 340. The cathode layers 340 are also preferably porous such that they may be aerated or otherwise accessed by oxidant. Anions produced at the cathode 340 may flow through the anion-conducting electrolyte toward an anode 360. Waste products, such as water, carbon dioxide and the like, are typically produced in both the anode layers 320 and cathode layers 340.

It is noted that the current produced per unit area by a double-electrolyte fuel-cell stack 300 may be larger than the current produced by a single-electrolyte fuel-cell stack of the prior art. It will be appreciated that the high current density output associated with embodiments of the double-electrolyte fuel-cell stack 300 is particularly useful in micro fuel-cells. Thus embodiments of the double-electrolyte fuel-cell stack 300 may be advantageous for example in applications, such as electronics and the like, where small footprints are required.

Furthermore, as noted above, the double-electrolyte fuel-cell stack 300 of the third embodiment does not require any interconnect layers. The interconnect layer of prior art fuel-cell stacks is not a functional part of the energy conversion mechanism of the fuel-cell itself serving only to electrically connect individual fuel-cells and to separate the fuel from the oxidant. Nevertheless, selection of materials for the interconnect layer for the effective construction of prior art fuel-cell stacks has proved problematic for a number of reasons as outlined below.

In order to ensure good electrical contact between fuel-cells it is important that the interconnect layer has a high electronic conductivity. At the same time, in order to prevent ionic leakage between adjacent fuel-cells, the ionic conductivity of the interconnect layer must be as small as possible. However, because the interconnect layer is typically exposed to both the oxidizing and reducing side of fuel-cells it is susceptible to oxidation. Thus interconnects need to be highly stable as oxidation may result in cracks and leakage between adjacent cells and/or deterioration of electronic conductivity with time. By allowing fuel-cell stacks to be constructed without any interconnect layers, embodiments of the present invention may avoid the abovementioned limitations of the prior art.

Thus various embodiments of the invention provide double-electrolyte fuel-cells including both anion-conducting electrolytes and cation-conducting electrolytes. Such double-electrolyte fuel-cells may provide electrochemical energy conversion with greater fuel-flexibility, higher efficiency, shorter start-up times and at lower running costs than single-electrolyte fuel-cells.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A double-electrolyte fuel-cell comprising:
a. at least one anode;
b. at least one cathode;
c. at least one anion-conducting electrolyte, and
d. at least one cation-conducting electrolyte, further comprising a fuel channel for delivering fuel to said anode and an oxidant channel for delivering oxidant to said cathode.

2. The fuel-cell of claim 1 wherein said at least one cation-conducting electrolyte is selected from the group consisting of: proton exchange membranes, alkaline solution, polymer membranes, nafion, polybenzimidazole fiber, molten phosphoric acid, and proton conducting ceramic oxides.

3. The fuel-cell of claim 1 wherein said at least one anion-conducting electrolyte is selected from the group consisting of: ceramic oxides, doped zirconium dioxide, doped cerium oxide, and molten alkaline carbonates.

4. (canceled)

5. (canceled)

6. A double-electrolyte fuel-cell comprising: an anode sandwiched between one anion-conducting electrolyte and one cation-conducting electrolyte; a first cathode in contact with said anion conducting electrolyte, and a second cathode in contact with said cation conducting electrolyte.

7. A fuel-cell stack comprising a plurality of double-electrolyte fuel-cells of claim 6 wherein an anode of at least a first fuel-cell is conductively connected to the cathodes of an adjacent second fuel-cell via an interconnect layer.

8. A fuel-cell stack comprising a plurality of double-electrolyte fuel-cells, each double-electrolyte fuel-cell comprising: a. at least one anode; b. at least one cathode; c. at least one anion-conducting electrolyte, and d. at least one cation-conducting electrolyte, the double-electrolyte fuel cells being conductively connected in series via electrically conductive interconnect layers.

9. (canceled)

10. The fuel-cell stack of claim 7, wherein each interconnect layer is perpendicular to the anodes and cathodes connected thereof.

11. The fuel-cell stack of claim 7, wherein the electrolyte layers of the fuel-cells and the anode of the second fuel-cell are insulated from the interconnect layer.

12. The fuel-cell of claim 6, wherein the anode is porous.

13. The fuel-cell of claim 6, further comprising a fuel channel for delivering fuel to said anode and oxidant channels for delivering oxidant to said cathodes.

14. The fuel-cell stack of claim 8, each fuel-cell further comprising a fuel channel for delivering fuel to said anode and an oxidant channel for delivering oxidant to said cathode.

15. The fuel-cell stack of claim 8, wherein the channels are porous, and each interconnect layer has an anode side and a cathode side, wherein a fuel channel on the anode side of the interconnect layer allows fuel to enter the fuel-cell and contact the anode, and an oxidant channel on the cathode side of the interconnect layer allows oxidant to enter the fuel-cell and contact the cathode.

16. The fuel-cell stack of claim 8, wherein the double-electrolyte fuel-cell have a hexagonal configuration, wherein each interconnect layer has a grooved upper surface providing an oxidant channel along a first axis, and a lower surface grooved along a second axis sixty degrees removed from the first axis.

17. The fuel-cell stack of claim 15, each fuel-cell further comprising a hexagonal porous waste collection layer sandwiched between the cation-conducting electrolyte and the anion-conducting electrolyte.

18. The fuel-cell stack of claim 16, wherein the collection layer is configured to allow waste to be drained along a third axis sixty degrees removed from both the first axis and the second axis.

19. The fuel-cell of claim 8, wherein the anodes are porous.

20. A fuel-cell stack comprising a plurality of conductively connected double-electrolyte fuel-cells of claim 6.
